(19) United States
(12) Patent Application Publication
(10) Pub. No.: US 2010/0097946 A1
(43) Pub. Date: Apr. 22, 2010

(54) OPTIMIZED DATA TRANSFER BETWEEN APPROACHING DEVICES

(75) Inventors: Ulrico CELENTANO, Oulu (FI); Juha SALOKANNEL, Tampere (FI); Harald KAAJA, Jarvenpaa (FI); Janne MARIN, Espoo (FI)

Correspondence Address: Locke Lord Bissell & Liddell LLP;Attn: IP Docketing, Three World Financial Center, New York, NY, 10281-2101, US

(73) Assignee: NOKIA CORPORATION, Espoo (FI)

(21) Appl. No.: 12/256,177

(22) Filed: Oct. 22, 2008

(51) Int. Cl. H04L 12/26

(52) U.S. Cl. 370/252

(57) ABSTRACT

A method, system, and computer program product are disclosed for passively sensing with a hot spot wireless device, a presence of beacon messages from any other wireless devices within a coverage area, ignoring active beacon group merging operations, allowing a mobile wireless device to join in the beacon group, within the coverage area and exchanging beacon messages with the mobile wireless device, actively sensing by exchanging a sequence of test frames with the mobile wireless device using a plurality of modes supported by both the mobile wireless device and the hot spot wireless device, and exchanging data with the mobile wireless device after the actively sensing step.

### FIELD

The technical field relates to wireless communications. More particularly, the technical field relates to techniques for managing communication between approaching wireless devices.

### BACKGROUND

The seven layers of the Open Systems Interconnection Basic Reference Model (OSI Model) are, from top to bottom, the Application layer 7, the Presentation layer 6, the Session layer 5, the Transport layer 4, the Network layer 3, the Data Link layer 2, and the Physical layer (PHY) 1. The Medium Access Control (MAC) sub-layer is part of the Data Link layer 2.

MAC layers govern the exchange among devices of transmissions called frames. A MAC frame may have various portions, including frame headers and frame bodies. A frame body includes a payload containing data associated with higher protocol layers, such as user applications. Examples of such user applications include web browsers, e-mail applications, messaging applications, and the like.

The WiMedia Alliance has developed an OFDM physical layer described in ECMA-368 and ISO/IEC-26907. These documents are incorporated herein by reference in their entirety and its subject matter is referred to herein as WiMedia.

The WiMedia Ultra-Wideband (UWB) Common Radio Platform incorporates high rate physical layer (PHY) techniques for short-range proximity networks. It involves frequency hopping applications of orthogonal frequency division multiplexing (OFDM). This technique involves the transmission of OFDM symbols at various frequencies according to pre-defined codes, such as Time Frequency Codes (TFCs). Time Frequency Codes can be used to spread interleaved information bits across a larger frequency band. The WiMedia Ultra-Wideband (UWB) Common Radio Platform incorporates media access control (MAC) layer and physical (PHY) layer specifications based on Multi-band Orthogonal Frequency Division Multiplexing (MB-OFDM). The WiMedia UWB enables short-range multimedia file transfers at high data rates with low energy consumption, and operates in the 3.1 to 10.6 GHz UWB spectrum.

The WiMedia PHY provides for various channels across a frequency range. These channels are referred to as logical channels. Each logical channel employs a different Time Frequency Code (TFC). As discussed above, TFCs specify a repeating time sequence in which various frequency bands within a frequency range are used. Thus, a device employing a TFC transmits at different frequencies at particular times specified by the TFC. Currently, the WiMedia PHY specifies each band having a 528 MHz bandwidth.

The WiMedia Alliance has developed a Medium Access Control (MAC) layer that can be used with an OFDM physical layer, such as the WiMedia PHY, which is also described in ECMA-368 and ISO/IEC-26907. This document is incorporated herein by reference in its entirety and its subject matter is referred to herein as WiMedia.

MAC layers govern the allocation of resources. For instance, each device requires an allocated portion of the available communication bandwidth to transmit frames. The WiMedia MAC involves a group of wireless communications devices, referred to as a beacon group, which are capable of communicating with each other. The timing of beacon groups is based on a repeating pattern of superframes in which the devices may be allocated communications resources. These communications resources may be in the form of one or more time slots, referred to as media access slots (MASs).

This MAC layer provides for the allocation of resources to be performed through beacons. Beacons are transmissions that devices use to convey control information in a repeating pattern. The superframes are divided into a beacon period (BP) for beacon transmissions and a data period, which is primarily for data transmissions. Control information can be conveyed either in beacons during the beacon period or in data frames during the data period. Each device in a beacon group is assigned a portion of bandwidth to transmit beacons.

Each superframe starts with a beacon period (BP), which has a maximum length of a specified number of beacon slots. The length of each beacon slot is also specified. Beacon slots in the beacon period (BP) are numbered in sequence, starting at zero. The first few beacon slots of a beacon period (BP) are referred to as signaling slots and are used, for example, to extend the BP length of neighbors. An active mode device transmits and receives beacons. When transmitting in a beacon slot, a device starts transmission of the frame in the medium at the beginning of that beacon slot. A device transmits beacons at a specified rate. The transmission time of beacon frames does not exceed a specified duration, which allows for a guard time of at least a specified duration between the end of a beacon and the start of the next beacon slot.

Such transmissions allow the WiMedia MAC to operate according to a distributed control approach, in which multiple devices share MAC layer responsibilities. Accordingly, the WiMedia MAC Specification provides various channel access mechanisms that allow devices to allocate portions of the transmission medium for communications traffic. These mechanisms include a protocol called the distributed reservation protocol (DRP) in which reservations for connections are distributed among devices. These mechanisms also include a protocol called prioritized contention access (PCA).

The distributed reservation protocol (DRP) enables devices to reserve one or more media access slots (MASs) that the device can use to communicate with one or more neighbors. All devices that use the distributed reservation protocol (DRP) for transmission or reception announce their reservations by including DRP information elements (IEs) in their beacons. A reservation is the set of MASs identified by DRP IEs with the same values in the Target/Owner DevAddr, Owner, and Reservation Type fields. Generally, reservation negotiation may be initiated by the device that will initiate frame transactions in the reservation, referred to as the reservation owner. The device that will receive information is referred to as the reservation target. A reservation defined by DRP IEs with the Owner/Target DevAddr field set to a multicast address (McstAddr) and the Owner bit set to one is referred to as a multicast reservation. A reservation defined by DRP IEs with the Owner bit set to zero and made in response to a multicast reservation is also referred to as a multicast reservation.

According to the WiMedia MAC Specification, there are rules for beacon group merging so that in case a node detects an alien beacon period that meets the criteria for beacon period merging, the node has to start merging with the alien beacon period.

### SUMMARY

A method, apparatus, system, and computer program product example embodiments of the invention are disclosed to enable a hot spot wireless device to perform data transfer with a mobile wireless device in substantially short time, to save channel time for other wireless customers of the hot spot. This is done by using high, predefined data rate(s) and substantially best available link quality to limit the number of retransmissions.

Example embodiments passively sense with the hot spot wireless device, a presence of beacon messages from any other wireless devices within a coverage area. The embodiments determine whether a received beacon message is from the same beacon group. The embodiments ignore active beacon group merging operations. The embodiments join a mobile wireless device in the beacon group, within the coverage area and exchange beacon messages with the mobile wireless device. The embodiments actively sense by exchanging a sequence of test frames with the mobile wireless device using a plurality of modes supported by both the mobile wireless device and the hot spot wireless device, in order to find high, predefined data rate(s) and substantially best available link quality to limit the number of retransmissions. The embodiments, then exchange data with the mobile wireless device.

In an example embodiment of the invention, a receiver in a wireless device is configured to receive within a beacon group, a plurality of beacon messages from a plurality of other wireless devices in the group across a wireless transmission medium. The beacon messages include information for maintaining coordination between wireless devices in the group. The beacon messages are sent in respective beacon slots reserved for respective ones of the wireless devices in the group. A processor coupled to the receiver is configured to receive a beacon message from a wireless device and determine whether the received beacon message is received from a wireless device synchronized to the beacon group. The processor is configured to ignore the received beacon message when the received beacon message is received from a wireless device not synchronized to the beacon group. The processor is further configured to allow the wireless device to join the beacon group when the received beacon message from the wireless device is synchronized to the beacon group. The processor is configured to actively sense by exchanging a sequence of test frames with the wireless device using a plurality of modes supported by the wireless device, to measure channel conditions of the wireless device during the actively sensing. The processor can then exchange data with the mobile wireless device. The processor may optionally request the wireless device to reduce its own beacon group size before allowing the wireless device to join the first named beacon group. The mobile device may also autonomously perform this reduction operation before joining the hot spot's beacon group. This could be temporarily done for a limited time only, for that session, or on a more permanent basis whenever near hot spot.

Example embodiments of the invention provide a hot spot node with means to service devices that operate according to the WiMedia standard specification, while ensuring that the hot spot node has means to ignore active beacon group merging operations. Embodiments of the invention service only nodes that can be serviced with higher data rates to ensure good QoS for the serviced nodes.

Example embodiments of the invention provide a software configuration for a hot spot device, which does not implement the active beacon merging operations that force encountering devices to merge with the hot spot devices in a beacon group.

Example embodiments of the invention provide a software configuration for a hot spot device, which operates during an actual service session initiation to enable the hot spot device to measure channel conditions of an encountering device. When the channel conditions meet a predefined threshold level, for example a reliable connection with high data rate link, the actual service session option is provided to the encountering device.

Example embodiments of the invention detect the approach of a mobile device, or the departure of a mobile device in relative movement. Example embodiments of the invention detect changing channel conditions.

Example embodiments of the invention postpone data transfer until it is possible to use high, predefined data rate(s).

Example embodiments of the invention postpone data transfer until the expected number of retransmissions is below a threshold.

Example embodiments of the invention perform sensing by sending a sequence of frames using all the modes supported by corresponding devices, or a subset of them, one or more frames per each mode.

Example embodiments of the invention avoid merging a hot spot device to other beacon groups.

Example embodiments of the invention use an optimization value to schedule the traffic exchange.

Example embodiments of the invention postpone the data exchange to wait for better conditions when the optimization value increases (channel quality improves).

Example embodiments of the invention enable the hot spot device to decide to not merge with other WiMedia devices, but to wait for them to merge with it.

Example embodiments of the invention enable the hot spot device to request an approaching beacon group to reduce its size before merging. This may reduce the length of the hot spot's beacon period, thus allowing a larger population of devices to be served, as well as providing a shorter beacon period length for mobile, energy-limited devices.

The primary application of the example embodiments is expected to be where the mobile devices are ECMA-368 legacy devices with relatively simple service software, whereas the hot spot devices contain more complex configurations and even some exceptions from the ECMA-368 standard. Typically, the hot spot device has more information as to what the service situation is for mobile devices. Thus, the possible required operations and/or exceptions should be performed by the hot spot device. The mobile device may perform the synchronization to the hot spot's beacon group and it may make application-level choices as to what to download, for example. However, the hot spot device should have the responsibility for making the measurements, the channel reservations in most instances, and the decision to start the mass data transmission.

As a result of the example embodiments of the invention, data transfer is performed in substantially short time, to save channel time for other customers of the hot spot. This is done by using high, predefined data rate(s) only, and also by limiting the number of retransmissions, even when using the same mode, due to a better channel.

### DESCRIPTION OF THE FIGURES

FIGS. 1A to 1F illustrate an example sequence of operational phases when a mobile device approaches and leaves the coverage area of a hot spot according to at least one example embodiment of the present invention.

FIG. 2A is a flow diagram of the example sequence of operational phases in FIGS. 1A to IF.

FIG. 2B is a flow diagram of example embodiments of the invention detecting the optimal link quality during the active sensing operational phase.

FIG. 3A is an example physical view of a network of wireless devices in Beacon Group G1, which includes the hot spot device A1, devices A2, A3, A4, A5 that are in the active mode and other devices that are in the hibernation mode. The mobile wireless device A6 is also shown approaching the coverage area of the hot spot device A1.

FIG. 3B is an example view of only the active devices in the Beacon Group G1 of FIG. 3A which includes the hot spot device A1, devices A2, A3, A4, A5, plus the approaching mobile wireless device A6.

FIG. 3C is a functional block diagram of an example embodiment of the hot spot wireless device A1.

FIG. 4A illustrates an example superframe format during the beacon group joining operational phase, with beacons of the hot spot device A1 and the other active devices A2, A3, A4, A5 transmitted in the beacon period of each superframe 102A, 102B, and 102C, and the beacon of the approaching mobile device A6.

FIG. 4B illustrates an example superframe format during the active sensing operational phase, with beacons of the hot spot device A1 and the other active devices A2, A3, A4, A5 transmitted in the beacon period of each superframe 102A, 102B, and 102C.

FIG. 4C shows an example of the hot spot device A1's beacon frame “A1 Beacon” in FIGS. 1B, 4A, and 4B.

FIG. 4D shows an example of the hot spot device A1's data frame “A1 Test Frame” in FIG. 1C and 4B.

FIG. 5 illustrates an example embodiment of hot spot service related to a seat in an airplane, or train, etc.

### DISCUSSION OF EXAMPLE EMBODIMENTS OF THE INVENTION

U.S. patent application Ser. No. 12/036,792 to Ulrico Celentano, Harald Kaaja, and Juha Salokannel, filed Feb. 25, 2008, entitled “Forwarding in Distributed Wireless Networks”, is incorporated herein by reference for its disclosure of various related modes of operation between wireless devices.

According to one or more non-limiting embodiments, a “hot spot” wireless device is an information source or sink, which may be static device and in typical exemplary applications, is intended to communicate with an approaching or mobile device. An example application of a “hot spot” wireless device is a multimedia kiosk. Since available data transmission rates of UWB communication are very dependant on the distance between the communicating nodes, it is not efficient to try to connect to and service each and every node within the range of a particular node, since the available data rate grows significantly if the node to be serviced is close to the hot spot node. Moreover, serving a stream with a lower data rate may lead to a larger need of resources, hence reducing resources available for other streams. Thus, when a hot spot node tries to service all mobile nodes within its coverage area, irrespective of the distance, the QoS may drop due to data reservations with more distant nodes that require smaller data rates for successful data exchange

Example embodiments of the invention enable a hot spot wireless device to perform data transfer with a mobile wireless device in substantially short time, to save channel time for other wireless customers of the hot spot. This is done by using high, predefined data rate(s) and substantially best available link quality to limit the number of retransmissions.

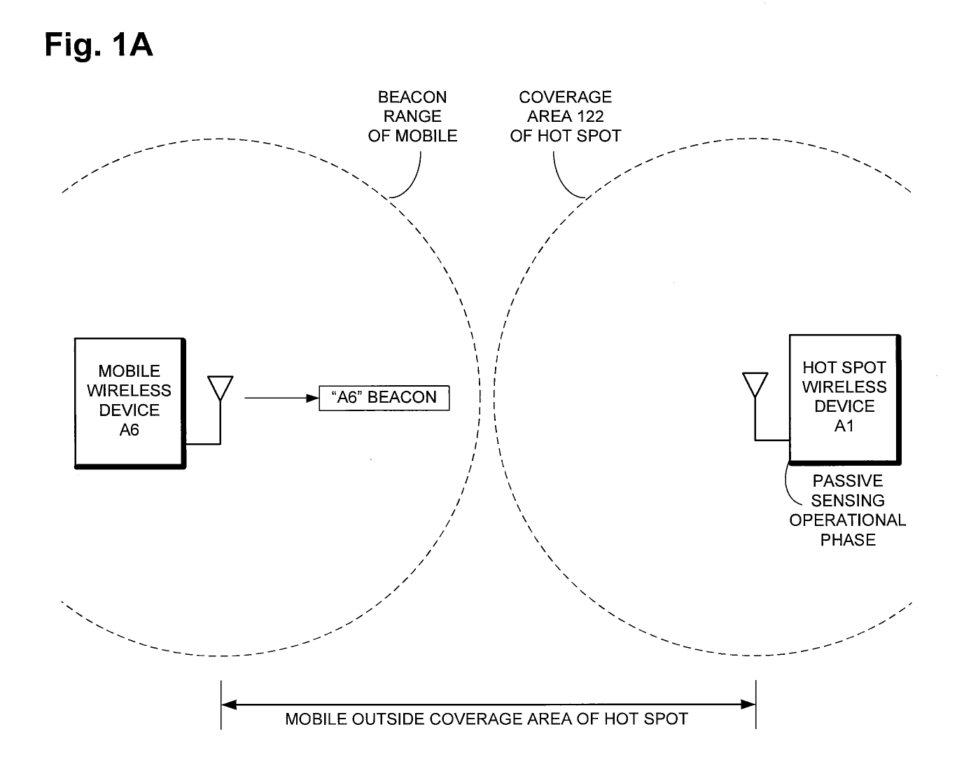

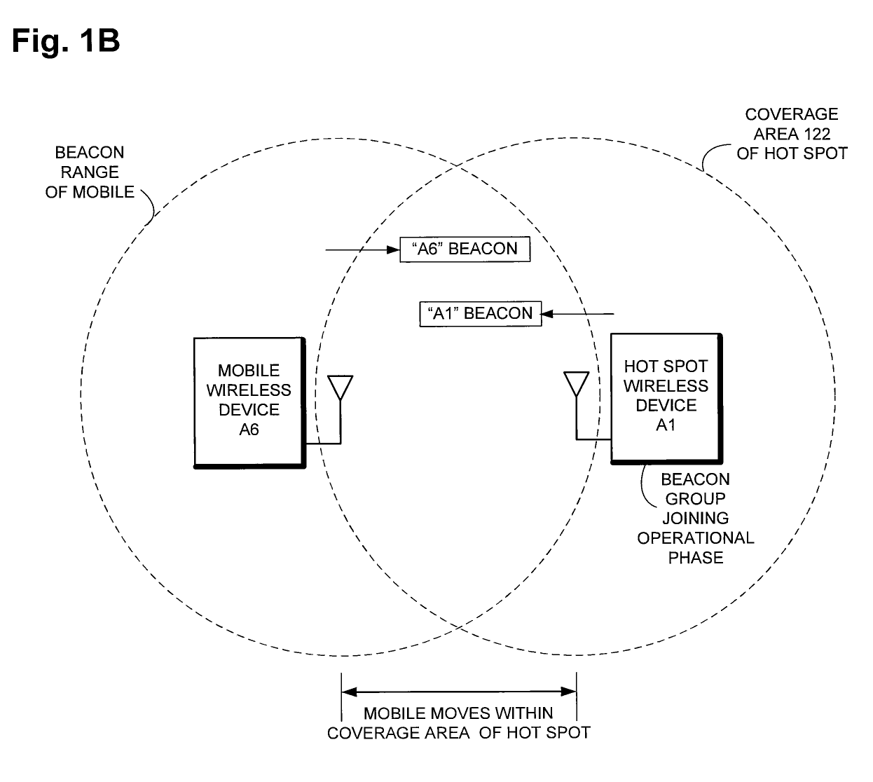

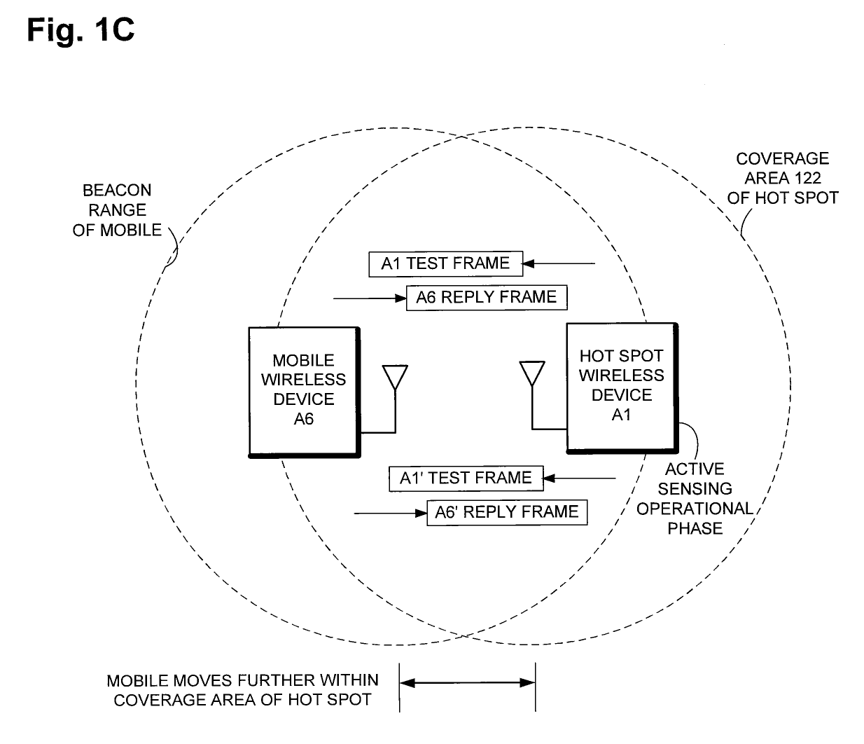

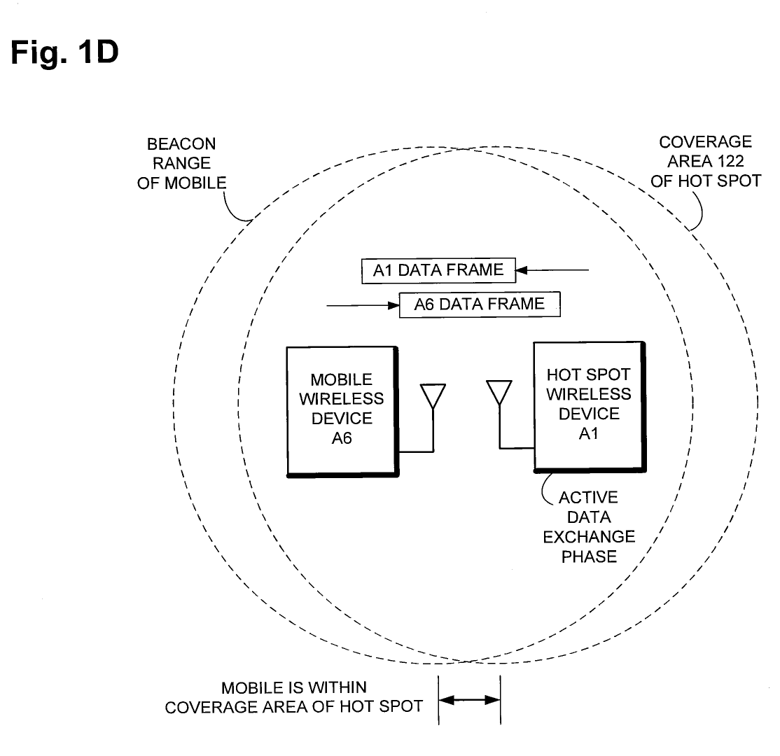

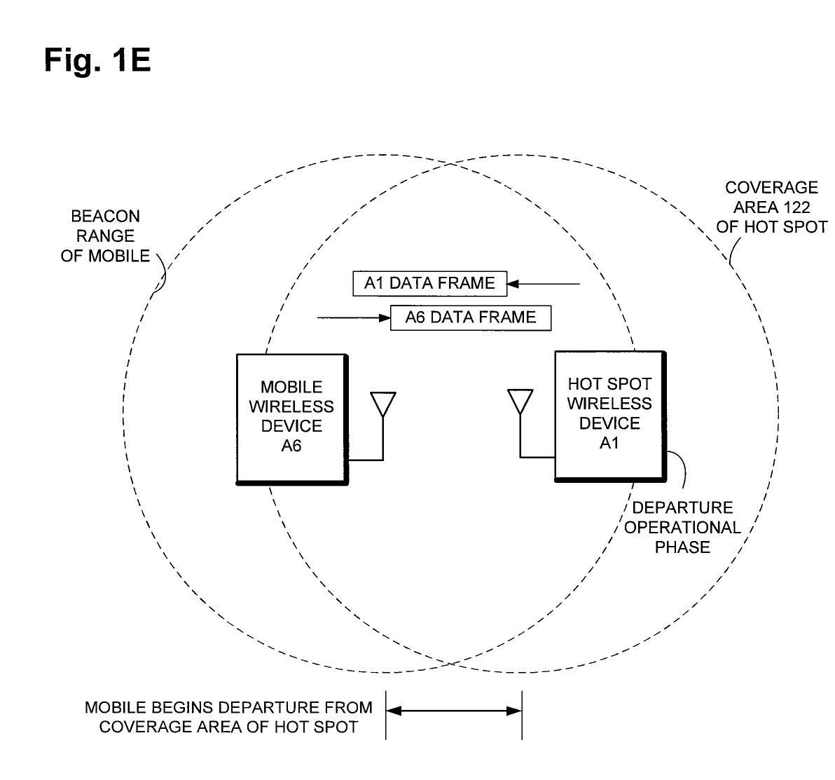

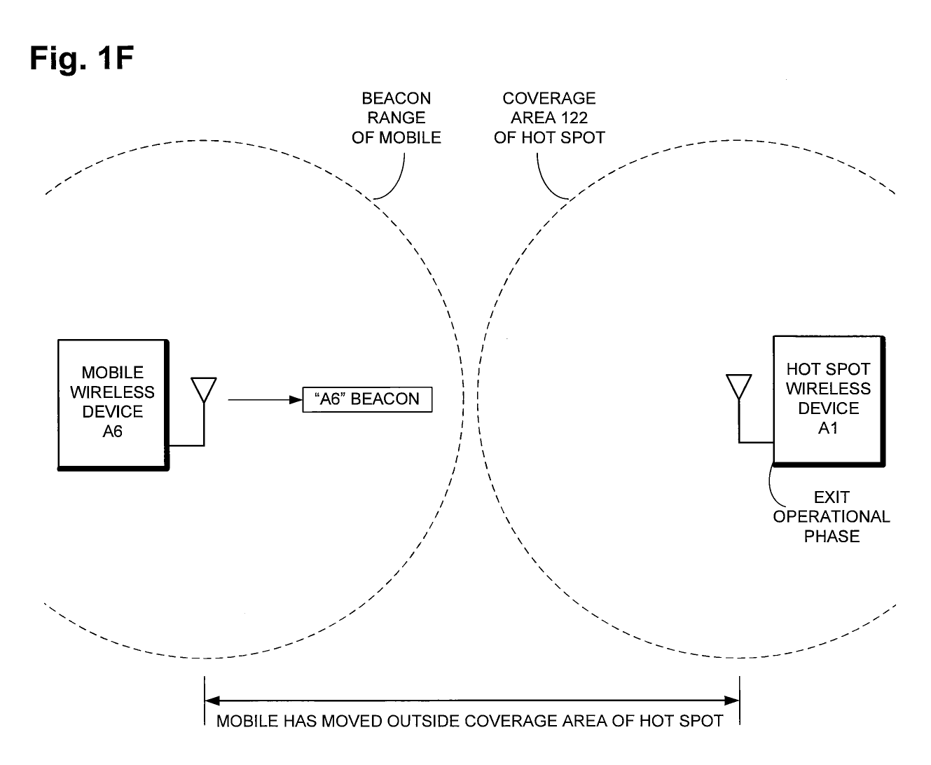

FIGS. 1A to 1F illustrate an example sequence of operational phases when a mobile wireless device A6 approaches and leaves the coverage area of a hot spot wireless device A1 according to at least one example embodiment of the present invention. The hot spot wireless device A1 may be an information source or sink, which is usually static and in certain applications, is intended to communicate with an approaching mobile wireless device A6. In this example embodiment, both the mobile wireless device A6 and the hot spot wireless device A1 communicate using the WiMedia MAC. The available data transmission rates of UWB communication are strongly dependant on the distance between the communicating nodes. Thus, the available data rate and link quality improve significantly as the mobile wireless device A6 approaches the hot spot wireless device A1, and vice versa when it moves further away.

In one example embodiment, in order to perform data transfer in substantially short time so as to save channel time for other wireless customers of the hot spot, the hot spot wireless device A1 performs a sequence of operational phases as the mobile wireless device A6 approaches, to obtain high, predefined data rate(s) with substantially best available link quality, before data transfer is conducted. Typically, the hot spot device A1 has more information as to what the service situation is for mobile devices A6. Thus, the possible required operations and/or exceptions should be performed by the hot spot device A1. The mobile device A6 may perform the synchronization to the hot spot's beacon group and it may make application-level choices as to what to download, for example. However, the hot spot device A1 may have the responsibility for making the measurements, the channel reservations in most instances, and the decision to start the mass data transmission.

In another example embodiment, it is the mobile wireless device A6 that performs the sequence of operational phases as the mobile wireless device A6 detects the presence of beacons from the hot spot wireless device A1, as the mobile wireless device A6 approaches, to obtain high, predefined data rate(s) with the preferred link quality, before data transfer is conducted.

FIG. 1A illustrates an example of the passive sensing operational phase of the hot spot wireless device A1 when the mobile wireless device A6 is outside the coverage area of the hot spot wireless device A1. In the passive sensing operational phase, hot spot wireless device A1 performs scanning for beacons from any other wireless devices A6 within its coverage area 122. The hot spot wireless device A1 receives the beacon “A6” from device A6. The hot spot wireless device A1 performs measurements on channel or propagation parameters (RSSI, for example) related to beacon reception, including approaching phase detection. The approaching mobile device A6, according to an example embodiment, is forced to synchronize to hot spot wireless device A1's beacon group and make a service request on the application level. Link measurements (with corresponding channel reservation) and the mass data flow may be controlled by the hot spot wireless device A1. Because the hot spot device typically has more information than mobile devices, the hot spot device A1 may have the responsibility for passive sensing. The mobile A6 may also do the passive sensing. The mobile may perform synchronization (“association”) to the hot spot's beacon group. The mobile may therefore able to detect the presence of the hot spot and this may be done by passive sensing.

In addition, the mobile wireless device A6 may instead, or in addition to the hot spot device A6, perform the passive sensing operational phase. The mobile device A6 is initially far from any coverage (thus including both the basic coverage and the possible extended coverage). The mobile device A6 does not receive any beacon or any other control frame, but it keeps scanning for possible beacons. At some position, it starts being able to detect the hot spot A1. From that position on, the mobile device A6 may track/listen to beacons from the hot spot A1, without joining the beacon group (referred to herein as beacon group joining).

FIG. 1B illustrates an example of the beacon group joining operational phase of the hot spot wireless device A1 when the mobile wireless device A6 moves within the coverage area of the hot spot wireless device A1. In the beacon group joining operational phase, hot spot wireless device A1 exchanges beacons with the mobile wireless device A6 during a beacon period. The hot spot wireless device A1 anticipates beacon group joining with respect to the actual data exchange time, which allows the hot spot wireless device A1 to reserve the required resources for the approaching mobile wireless device A6. Because the hot spot device typically has more information than mobile devices, the hot spot device A1 may have the responsibility for initiating the joining phase. The mobile A6 may also do the passive sensing. The mobile may performing synchronization (“association”) to the hot spot's beacon group. The mobile may therefore able to detect the presence of the hot spot and this may be done by passive sensing. The hot spot wireless deviceA1 may delay actual data exchange when the mobile device A6 is approaching the hot spot A1, to allow the hot spot to reserve the required resources for the anticipated service. The mobile device A6 or the hot spot device A1 may set a threshold, for example in the received signal strength or in time, at which it will start the beacon group joining phase.

In another example embodiment, it is the mobile wireless device A6 that performs the beacon group joining operational phase. When the mobile device A6 reaches the position at which the presence of hot spot A1 starts to be detected, as the mobile device A6 further approaches the hot spot device A1, beacon group joining becomes possible with the hot spot device A1. As the mobile device A6 continues to approach the hot spot device A1, it arrives at the position at which data transfer may be initiated. Beacon group joining time may be determined depending on service need, and possibly network congestion, if known.

FIG. 1C illustrates an example of the active sensing operational phase of the hot spot wireless device A1 when the mobile wireless device A6 moves further within the coverage area of the hot spot wireless device A1. In the active sensing operational phase, hot spot wireless device A1 may engage in bi-directional testing by sending a sequence of test frames using all the modes or a subset of modes supported by both the mobile wireless device A6 and the hot spot wireless device A1. The hot spot wireless device A1 may send one or more test frames per each mode and the mobile wireless device A6 may send reply frames back to the hot spot. The reply frames can be analyzed by the hot spot wireless device A1 for error rates, RSSI, and other channel or propagation parameters indicating link quality. Because the hot spot device typically has more information than mobile devices, the hot spot device A1 may have the responsibility for the active sensing phase, making the measurements, the channel reservations in most instances, and the decision to start the mass data transmission.

In another example embodiment, it is the mobile wireless device A6 that may perform the active sensing operational phase. The estimated or actual data size to be transferred may be a possible factor in this phase. The speed of approach of the mobile device A6 to the hot spot device A1 may be another possible factor in this phase. The expected time the mobile device A6 will reach proper coverage with the hot spot device A1 may yet be another possible factor in this phase. The expected time the mobile device A6 will stay within that coverage may yet be another possible factor in this phase. The mobile device A6 or the hot spot device A1 may set a threshold, for example in the received signal strength or in time, at which it will start the beacon group joining phase. Similarly, the duration useful for optimized data exchange corresponds to when the mobile device A6 enters and leaves the coverage area of the hot spot device A1.

FIG. 1D illustrates an example of the data exchange operational phase of the hot spot wireless device A1 when the mobile wireless device A6 is within the coverage area of the hot spot wireless device A1.

In another example embodiment, it is the mobile wireless device A6 that performs the data exchange operational phase. The exact values for when beacon group joining starts and when data transfer starts may depend on receiver sensitivity and transmitter coverage. Other factors include the mobile's speed and the estimated channel time required for data transfer. In this way, the communication link may be used at its optimum performance and for the shortest time with positive impact on energy consumption and on data transfer delay. Based on the same considerations, the mobile device A6 or the hot spot A1 may set another threshold for data transfer at which the upload or download procedure will start. The mobile device A6 or hot spot A1 may then start acquiring resources to upload or starts enquiry procedure for download. This point is estimated to give optimum choice for good coverage.

FIG. 1E illustrates an example of the departure operational phase of either the mobile wireless device A6 or of the hot spot wireless device A1 when the mobile wireless device A6 begins moving away from the coverage area of the hot spot wireless device A1. In the departure operational phase, data transmission is still ongoing and the operational phase is not yet ended, but it will end soon, because the retransmission value level is becoming worse again. In the departure phase, there are options to change the scheduling, for example to finish faster or alternately to drop it because the link is not good enough for high rate modes.

FIG. 1F illustrates an example of the exit operational phase of the hot spot wireless device A1 when the mobile wireless device A6 leaves the coverage area of the hot spot wireless device A1. In another example embodiment, it is the mobile wireless device A6 that performs the exit operational phase.

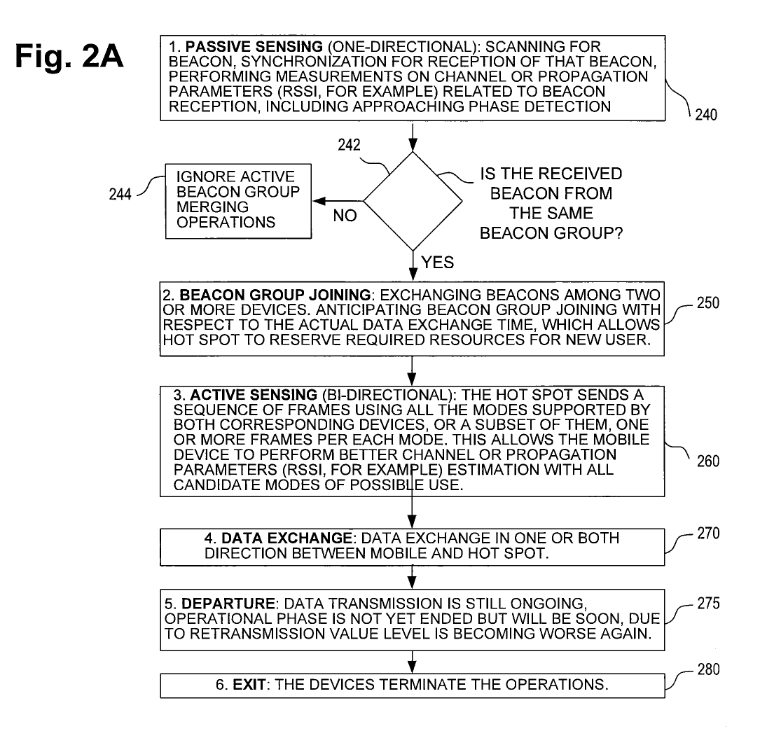

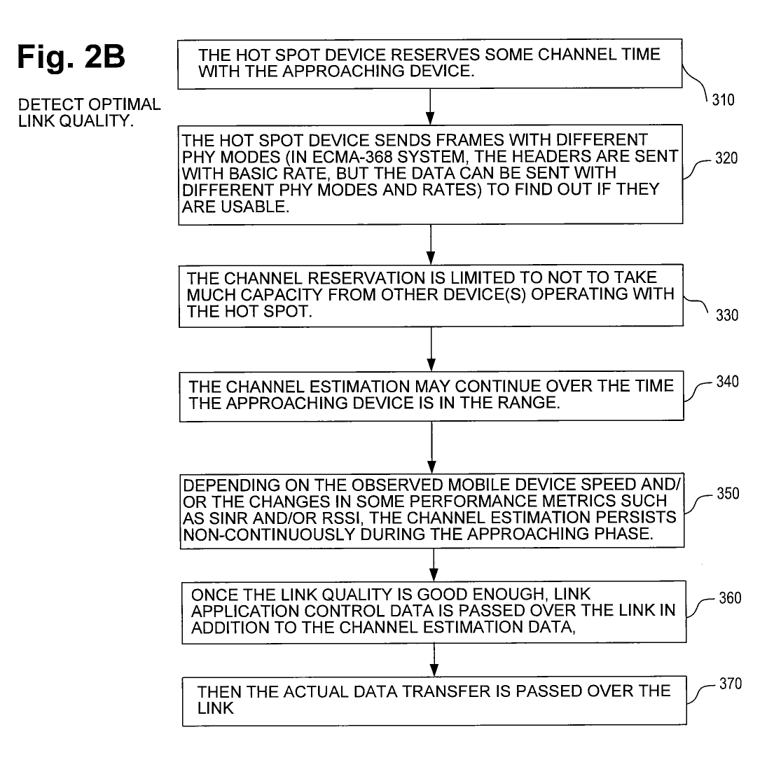

FIG. 2A is a flow diagram of the example sequence of operational phases in FIGS. 1A to 1F. Steps 240 to 280 are the method steps for FIGS. 1A to 1F, respectively. Step 240 is an example of the passive sensing operational phase of either the mobile wireless device A6 or the hot spot wireless device A1 when the mobile wireless device A6 is outside the coverage area of the hot spot wireless device A1. In the passive sensing operational phase, hot spot wireless device A1 may perform scanning for beacons from any other wireless devices A6 within its coverage area 122. The hot spot wireless device A1 performs synchronization for reception of the beacon “A6” from device A6. The hot spot wireless device A1 may perform measurements on channel or propagation parameters (RSSI, for example) related to beacon reception, including approaching phase detection. In another example embodiment, it is the mobile wireless device A6 that performs the passive sensing operational phase.

Step 242 is a decision whether the beacon group requires action such as merging. If it is, the process flows to step 250. If, for the received beacon, it is determined such that no action is needed, then step 244 is to ignore active beacon group merging operations. This step is to prevent the application of the WiMedia Specification's requirement in its Section 8.2.6 “Merger of Multiple BPs” (The corresponding ECMA-368 specification section number is 17.2.6.) This is a requirement for beacon group merging when a node, such as, for example the hot spot device A1 detects an alien beacon period, which otherwise meets the criteria for beacon period merging. If the hot spot device A1 were required to start merging with an alien beacon period, this may result in a significant decrease in QoS, since as all other serviced devices belonging to the hot spot device's A1 beacon group would have to switch to the new beacon group. Thus, embodiments of the invention enable the hot spot device A1 to service wireless devices operating according to the WiMedia specification, and yet enable the hot spot device to ignore active beacon group merging operations with alien beacon periods.

In some circumstances, an approaching beacon group may be requested to reduce the size of its beacon group before merging. (In practice, the user would shut-off unneeded peripherals.) This may reduce the length of the hot spot's beacon period, thus allowing a larger population of devices to be served, as well as providing a shorter beacon period length for mobile, energy-limited devices.

Step 250 is an example of the beacon group joining operational phase of either the mobile wireless device A6 or of the hot spot wireless device A1 when the mobile wireless device A6 moves within the coverage area of the hot spot wireless device A1. In the beacon group joining operational phase, hot spot wireless device A1 exchanges beacons with the mobile wireless device A6. The hot spot wireless device A1 anticipates beacon group joining with respect to the actual data exchange time, which allows the hot spot wireless device A1 to reserve the required resources for the approaching mobile wireless device A6. In another example embodiment, it is the mobile wireless device A6 that performs the beacon group joining operational phase.

Step 260 is an example of the active sensing operational phase of either the mobile wireless device A6 or of the hot spot wireless device A1 when the mobile wireless device A6 moves further within the coverage area of the hot spot wireless device A1. In the active sensing operational phase, hot spot wireless device A1 engages in bi-directional testing by sending a sequence of test frames using all the modes or a subset of modes supported by both the mobile wireless device A6 and the hot spot wireless device A1. The hot spot wireless device A1 sends one or more test frames per each mode and the mobile wireless device A6 sends reply frames back to the hot spot. The reply frames can be analyzed by the hot spot wireless device A1 for error rates, RSSI, and other channel or propagation parameters indicating link quality. In another example embodiment, it is the mobile wireless device A6 that performs the active sensing operational phase.

Step 270 is an example of the data exchange operational phase of either the mobile wireless device A6 or of the hot spot wireless device A1 when the mobile wireless device A6 is within the coverage area of the hot spot wireless device A1. In another example embodiment, it is the mobile wireless device A6 that performs the data exchange operational phase.

Step 275 is an example of the departure operational phase of either the mobile wireless device A6 or of the hot spot wireless device A1 when the mobile wireless device A6 begins moving away from the coverage area of the hot spot wireless device A1. In the departure operational phase, data transmission is still ongoing and the operational phase is not yet ended, but it will end soon, because the retransmission value level is becoming worse again. In the departure phase, there are options to change the scheduling, for example to finish faster or alternately to drop it because the link is not good enough for high rate modes.

Step 280 is an example of the exit operational phase of the hot spot wireless device A1 when the mobile wireless device A6 leaves the coverage area of the hot spot wireless device A1. In another example embodiment, it is the mobile wireless device A6 that performs the exit operational phase.

FIG. 2B is a flow diagram of example embodiments of the invention detecting the optimal link quality during the active sensing operational phase.

In step 310, for the purpose of detecting the optimal link quality, the hot spot device A1 may reserve some channel time with the approaching mobile device A6.

In step 320, the hot spot device A1 may send frames with different PHY modes (in the ECMA-368 system, the headers are sent with basic rate, but the data can be sent with different PHY modes and rates) to find out if they are usable.

In step 330, the channel reservation may be limited in a manner to not to take much capacity from other device(s) operating with the hot spot.

In step 340, the channel estimation may continue over the time the approaching device is in the range (or it may be stopped when the service is done).

In step 350, depending on the observed mobile device speed and/or the changes in some performance metrics such as SINR and/or RSSI, the channel estimation persists non-continuously during the active sensing phase while the mobile dice approaches.

In step 360, once the link quality is good enough, such as, e.g. meeting a predefined threshold level, link application control data can be passed over the link in addition to the channel estimation data, which may also be dummy data.

In step 370, the actual data transfer is made over the link and the data exchange operational phase commences.

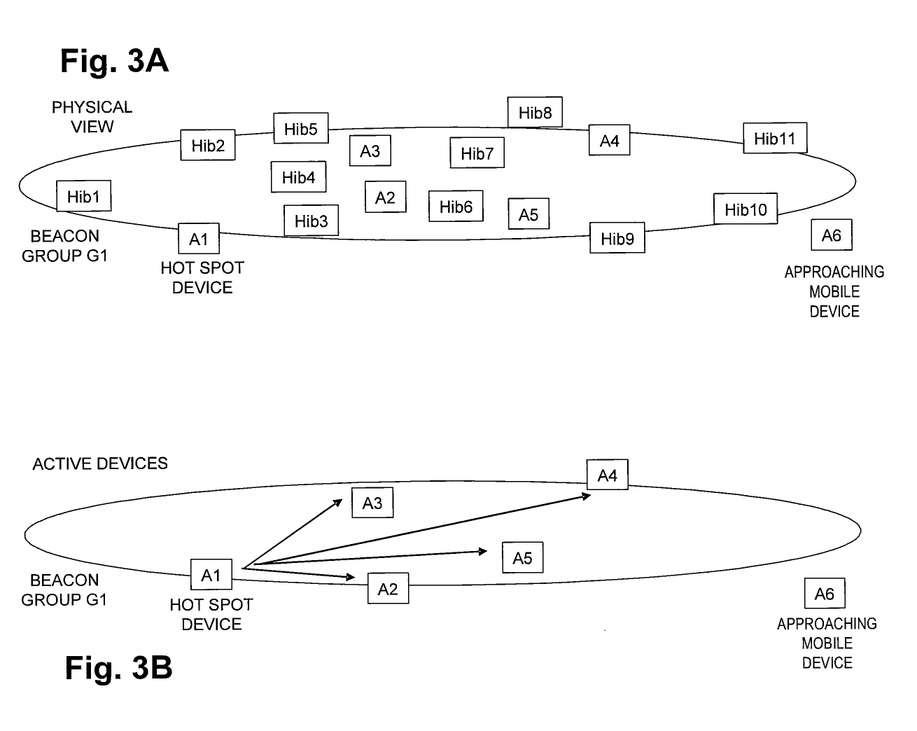

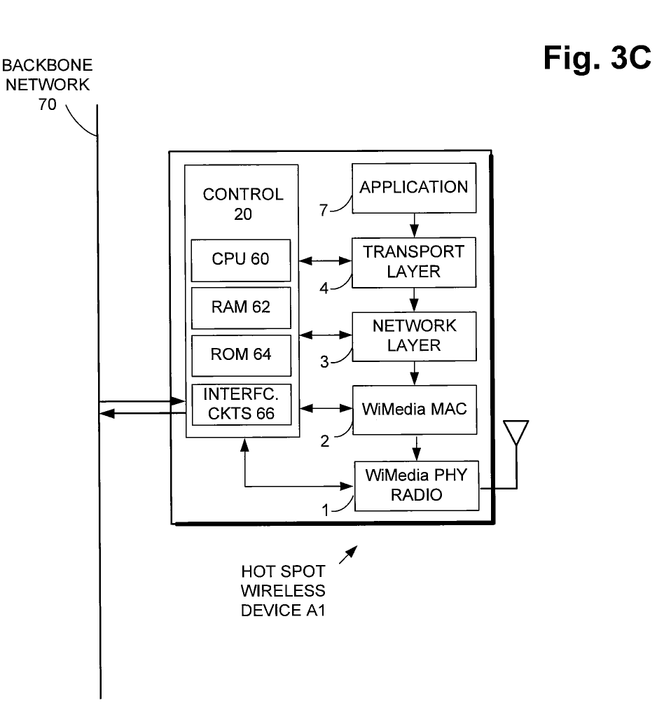

FIG. 3A is an example physical view of a short-range proximity network of wireless devices in a Beacon Group G1, incorporating the high rate physical layer (PHY) techniques the WiMedia Ultra-Wideband (UWB) Common Radio Platform. A Beacon Group is a set of wireless devices from which a device receives beacons that identify the same beacon period start time (BPST) as the receiving device. Beacon Group GI includes the hot spot wireless device A1 and other wireless devices A2, A3, A4, A5 that are in the active mode and devices Hib1 to Hib11 that are in the hibernation mode. Devices A1, A2, A3, A4, and A5 in the active mode transmit and receive beacons in every superframe. Devices Hib1 to Hib11 in the hibernation mode hibernate for multiple superframes to save energy and do not transmit or receive during those superframes. To coordinate with neighboring devices, a device indicates its intention to hibernate by including a Hibernation Mode information element (IE) in its beacon. The Hibernation Mode IE specifies the number of superframes in which the device will hibernate and will not send or receive beacons or any other frames. The mobile wireless device A6 is also shown in FIG. 3A, which is approaching the coverage area of the hot spot wireless device A1. FIG. 3B is an example view of only the active devices A1, A2, A3, A4, A5 in the Beacon Group G1 of FIG. 3A, plus the approaching mobile wireless device A6.

FIG. 3C is a functional block diagram of an example embodiment of the hot spot wireless device A1 or alternately the mobile wireless device A6. The wireless device A6 may be for example a mobile communications device, PDA, cell phone, laptop or palmtop computer, or the like. The hot spot wireless device A1 may be an information source or sink, which is usually static and can be connected to a wireless or wired backbone network 70. In typical applications, the hot spot wireless device A1 is intended to communicate with an approaching mobile wireless device A6. Both the wireless devices A6 and A1 include a control module 20, which includes a central processing unit (CPU) 60, a random access memory (RAM) 62, a read only memory (ROM) 64, and interface circuits 66 to interface with the WiMedia PHY radio 1, battery and other energy sources, key pad, touch screen, display, microphone, speakers, ear pieces, camera or other imaging devices, etc. The RAM 62 and ROM 64 can be removable memory devices such as smart cards, SIMs, WIMs, semiconductor memories such as RAM, ROM, PROMS, flash memory devices, etc. The Transport Layer 4, Network Layer 3, and WiMedia MAC sub-layer in Layer 2, and/or application program 7 can be embodied as program logic stored in the RAM 62 and/or ROM 64 in the form of sequences of programmed instructions which, when executed in the CPU 60, carry out the functions of the disclosed embodiments. The program logic can be delivered to the writeable RAM, PROMS, flash memory devices, etc. 62 of the device A6 or A1 from a computer program product or article of manufacture in the form of computer-usable media such as resident memory devices, smart cards or other removable memory devices, or in the form of program logic transmitted over any transmitting medium which transmits such a program. Alternately, the Transport Layer 4, Network Layer 3, and WiMedia MAC sub-layer in Layer 2, and/or application program 7 can be embodied as integrated circuit logic in the form of programmed logic arrays or custom designed application specific integrated circuits (ASIC). The WiMedia PHY radio 1 in device A6 or A1 operates at high data rates with low energy consumption in the 3.1 to 10.6 GHz UWB spectrum.

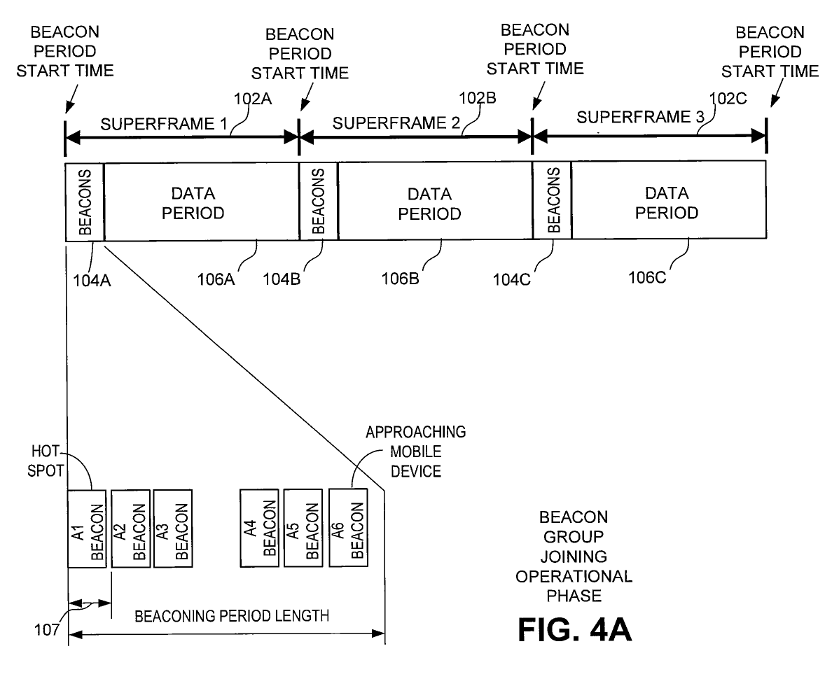

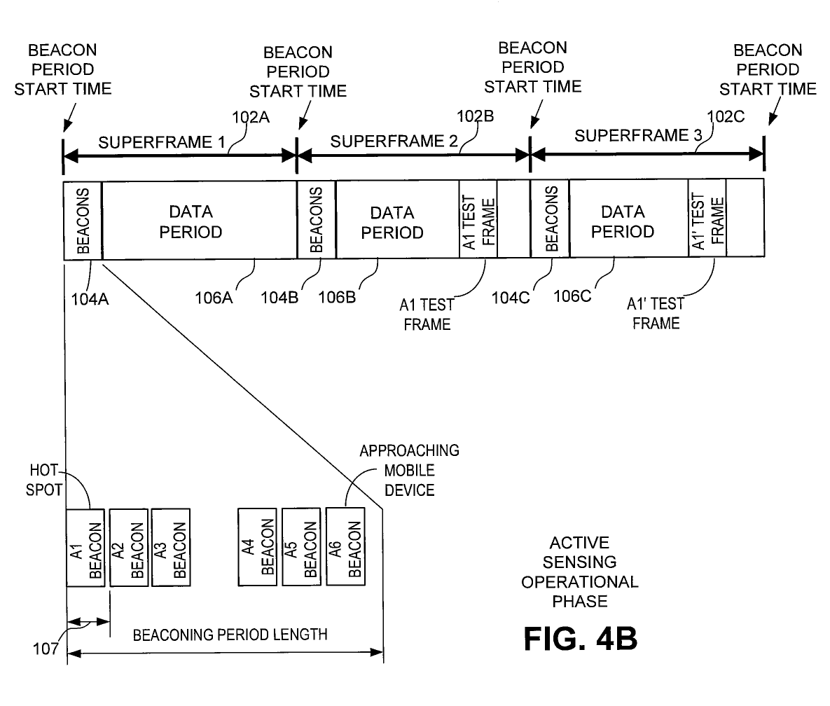

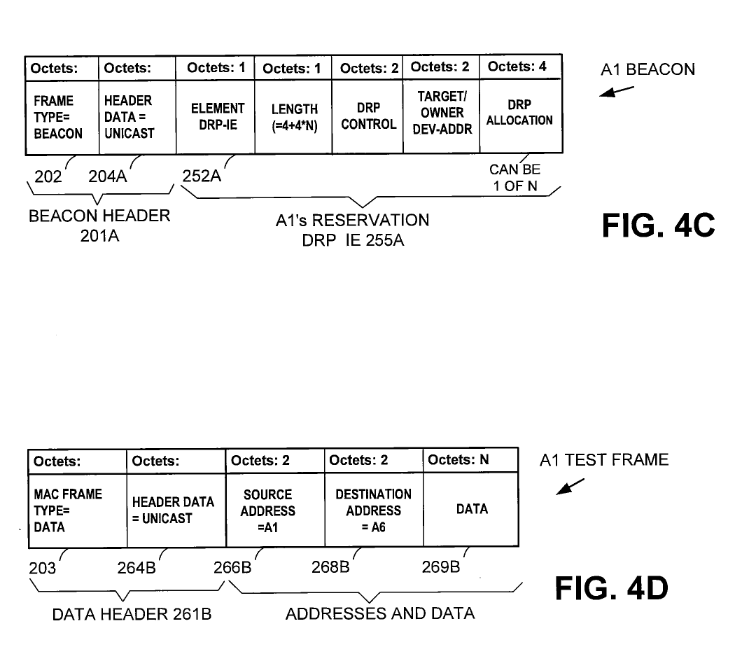

FIG. 4A illustrates an example superframe format during the beacon group joining operational phase, with beacons of the hot spot device A1 and the other active devices A2, A3, A4, A5 transmitted in the beacon period of each superframe 102A, 102B, and 102C, and the beacon of the approaching mobile device A6. The example superframe format is shown in FIG. 4A with superframes 102A, 102B, and 102C. Each superframe 102 includes a beacon period (BP) 104 and a data transfer period (DTP) 106. The Medium Access Control (MAC) sub-layer of the Data Link layer 2 in each device governs the exchange of beacon frames. Beacon periods 104 convey beacon frames, which are transmitted from each of the active devices in the beaconing group. Accordingly, each beacon period 104 includes multiple beacon slots 107. Slots 107 each correspond to a particular device, the hot spot wireless device A1 and the other wireless devices A2, A3, A4, and A5 in the network. The devices employing beacon slots 107 are referred to as a beaconing group. During these slots, the corresponding device may transmit various overhead or networking information, for example, to set resource allocations and to communicate management information for the beaconing group. For WiMedia networks, such information is transmitted in Information Elements (IEs).

The data transfer period 106 is used for devices to communicate data according to various transmission schemes, for example, frequency hopping techniques that employ OFDM and/or time frequency codes (TFCs). In addition, devices may use data transfer periods 106 to transmit control information, such as request messages to other devices, and the WiMedia MAC provides for command and control frames for the transfer of such information. To facilitate the transmission of traffic, each device may be allocated one or more scheduled time slots within each data transfer period 106, which are referred to as media access slots (MASs) in which two or more devices can exchange data. Media access slots (MASs) may be allocated among devices within the beacon group by the distributed reservation protocol (DRP), which protects the MASs from contention access by devices acknowledging the reservation. Alternatively, resource allocation can be provided according to a prioritized contention access (PCA) protocol, which is not constrained to reserving one or more entire MASs, but instead, can be used to allocate any part of the superframe that is not reserved for beaconing or DRP reservations. The WiMedia frame format has successive superframes 102, each of which includes 256 media access slots (MASs) and has a duration of 65,536 microseconds. Within each superframe 102, a first set of media access slots (MASs) is designated as the beaconing period 104, in which the number of MASs is flexible and may dynamically change. Various information elements (IEs) are transmitted in the beacon frame to transmit control information, including for example distributed reservation protocol (DRP) IEs, which are used to negotiate a reservation for certain media access slots (MASs) in the data transfer period 106 and to announce the reserved MASs. The remaining non-beaconing period portion of superframe 102 is the data transfer period 106.

Note that during the beacon group joining operational phase, FIG. 4A shows the approaching mobile device A6 transmitting its beacon “A6 Beacon” in the beacon period of the beacon group G1.

Also note that during the beacon group joining operational phase, FIG. 4A shows the hot spot device A1's beacon frame “A1 Beacon” of FIG. 4C transmitted to reserve slots in the data transfer period 106 to transmit test frames to the approaching mobile device A6.

FIG. 4B illustrates an example superframe format during the active sensing operational phase, with beacons of the hot spot device A1 and the other active devices A2, A3, A4, A5 transmitted in the beacon period of each superframe 102A, 102B, and 102C. FIG. 4B shows the packets in the superframe during the active sensing operational phase. The approaching mobile device A6 is transmitting its beacon in the beacon period of the beacon group G1. Beacon slots 107 each correspond to a particular device, the hot spot wireless device A1 and the other wireless devices A2, A3, A4, and A5 in the network.

Also note that during the active sensing operational phase, FIG. 4B shows the hot spot device A1's data frame “A1 Test Frame” of FIG. 4D is being transmitted to the mobile device A6 in the data transfer period 106B and A1's data frame “A1’ Test Frame” transmitted in the data transfer period 106 C.

FIG. 4C shows an example of the hot spot device A1's beacon frame “A1 Beacon” in FIGS. 1B, 4A, and 4B. The hot spot device A1's beacon frame “A1 Beacon” of FIG. 4C is transmitted to reserve slots in the data transfer period 106 to transmit test frames to the approaching mobile device A6. The beacon frame includes the beacon header 201A with field 202 that identifies the MAC frame as a beacon frame and field 204A that identifies the transmission as unicast. The payload portion of the beacon frame conveys the Reservation DRP IE 255A, which includes fields 252A for the DRP-IE element, length (4+4*N for N number of DRP allocation fields), DRP control, target/owner DevAddr, and one or more DRP allocation fields.

FIG. 4D shows an example of the hot spot device A1's data frame “A1 Test Frame” in FIGS. 1C and 4B, conveying test data to the mobile device A6, which includes the data header 261B with field 203 that identifies the MAC frame as a data frame and field 264B that identifies the transmission as unicast. The payload portion of the data frame includes the source address of hot spot device A1 in field 266B and the destination address of the mobile device A6 indicated in field 268B. The data is in the data field 269B. Any frame that does not have a low hamming weight should be good as a test frame.

The primary application of the example embodiments is expected to be where the mobile devices are ECMA-368 legacy devices with relatively simple service software, whereas the hot spot devices contain more complex configuration and even some exceptions from the ECMA-368 standard. Typically, the hot spot device has more information as to what the service situation is for mobile devices. Thus, the possible required operations and/or exceptions should be performed by the hot spot device. The mobile device may perform the synchronization to the hot spot's beacon group and it may make application-level choices as to what to download, for example. However, according to an example embodiment, the hot spot device should have the responsibility for making the measurements, the channel reservations in most instances, and the decision to start the mass data transmission.

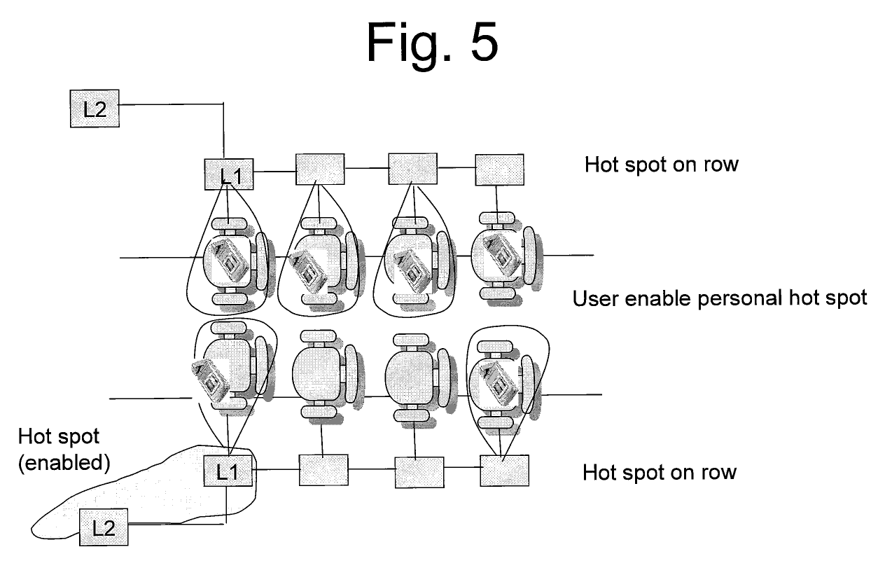

FIG. 5 illustrates an example embodiment of hot spot service related to a seat in an airplane, or train, etc. In the passive sensing phase, the hot spot detects the approaching device by receiving its beacons and the advertisement of services can be made after a common beacon group is set up. The hot spot detects the approaching device and advertises its services (movies, multimedia, etc.), e.g., by use of an Identification IE. The user then selects it and uses it. The hot spot can even be disabled, or hibernating and wakes up periodically to listen for a possible beacon in the passive sensing phase. This mechanism can also inform others whether a seat is empty. The hot spot may sense the presence of beacons sent by a mobile device and a beacon group is then built.

A device powering on outside of coverage area of a hot spot, undergoes a virtual phase zero and possibly enters at some time the passive sensing phase 240. A device powering on within the coverage area of a hot spot, will go to the beacon group joining phase 250 directly. Devices terminating abruptly their operations, e.g., due to faults or end of energy, will go, together with their corresponding device to the exit phase 280. The devices under consideration may undergo one or more of the above phases. For example, a device may skip the beacon group joining phase 250, active sensing phase 260, and data exchange phase 270 and exit directly; or it may skip the active sensing phase 260, if considered that existing data is still relevant, etc.

The resulting embodiments of the disclosed invention may be implemented together with the methods disclosed in the copending U.S. patent application Ser. No. 12/036,792 cited above, to provide a more efficient and prompt method for forwarding data to devices that are currently in hibernation mode or are otherwise not reachable by the initiating device. The device embodiments of the invention have a reduced complexity, since there are no network layer routing tables required and there is less protocol overhead. Moreover, the embodiments of the invention consider explicitly the case of hibernating destinations and the case of dynamic topology due to changing link conditions.

The principles of the disclosed embodiments may be applied to data transfer between a pair of peer devices, as well as to data transfer between one hot spot and one mobile device.

Using the description provided herein, the embodiments may be implemented as a machine, process, or article of manufacture by using standard programming and/or engineering techniques to produce programming software, firmware, hardware or any combination thereof.

Any resulting program(s), having computer-readable program code, may be embodied on one or more computer-usable media such as resident memory devices, smart cards or other removable memory devices, or transmitting devices, thereby making a computer program product or article of manufacture according to the embodiments. As such, the terms “article of manufacture” and “computer program product” as used herein are intended to encompass a computer program that exists permanently or temporarily on any computer-usable medium or in any transmitting medium which transmits such a program.

As indicated above, memory/storage devices include, but are not limited to, disks, optical disks, removable memory devices such as smart cards, SIMs, WIMs, semiconductor memories such as RAM, ROM, PROMS, etc. Transmitting mediums include, but are not limited to, transmissions via wireless communication networks, the Internet, intranets, telephone/modem-based network communication, hard-wired/cabled communication network, satellite communication, and other stationary or mobile network systems/communication links.

Although specific example embodiments have been disclosed, a person skilled in the art will understand that changes can be made to the specific example embodiments without departing from the spirit and scope of the invention. For instance, the features described herein may be employed in networks other than WiMedia networks.

What is claimed is:

1. A method, comprising:
participating in a beacon group;
receiving a beacon message from a wireless device;
determining whether the received beacon message is received from a wireless device synchronized to the beacon group; and
ignoring the received beacon message when the received beacon message is received from a wireless device not synchronized to the beacon group;
wherein participating in the beacon group comprises transmitting beacons across a wireless transmission medium, including information for maintaining synchronization between wireless devices in the group, the beacon transmissions being sent in respective beacon slots reserved for respective ones of the wireless devices in the group.

2. The method of claim 1, further comprising:
allowing the wireless device to join the beacon group when the received beacon message from the wireless device is synchronized to the beacon group.

3. The method of claim 2, further comprising:
actively sensing by exchanging a sequence of test frames with the wireless device using a plurality of modes supported by the wireless device.

4. The method of claim 3, further comprising:
measuring channel conditions of the wireless device during said actively sensing.

5. The method of claim 3, further comprising:
exchanging data with the wireless device after the actively sensing step.

6. The method of claim 3, further comprising:
said actively sensing postponing data transfer until it is possible to use a predefined usable rate.

7. The method of claim 3, further comprising:
said actively sensing postponing data transfer until an expected number of retransmissions is below a threshold.

8. The method of claim 3, further comprising:
said actively sensing postponing data exchange to wait for better conditions when channel quality improves.

9. The method of claim 3, further comprising:
said actively sensing giving higher priority to data exchange when channel quality decreases, before conditions become too bad for communication.

10. The method of claim 1, further comprising:
requesting the wireless device to reduce its own beacon group size before allowing the wireless device to join the first named beacon group.

11. An apparatus, comprising:
a receiver in a wireless device, configured to receive within a beacon group, a plurality of beacon messages from a plurality of other wireless devices in the group across a wireless transmission medium, wherein the beacon messages include information for maintaining coordination between wireless devices in the group, the beacon messages being sent in respective beacon slots reserved for respective ones of the wireless devices in the group; and
a processor coupled to the receiver, configured to:
receive a beacon message from a wireless device;
determine whether the received beacon message is received from a wireless device synchronized to the beacon group; and
ignore the received beacon message when the received beacon message is received from a wireless device not synchronized to the beacon group.

12. The apparatus of claim 11, further comprising:
said processor configured to:
allow the wireless device to join the beacon group when the received beacon message from the wireless device is synchronized to the beacon group.

13. The apparatus of claim 12, further comprising:
said processor configured to:
actively sense by exchanging a sequence of test frames with the wireless device using a plurality of modes supported by the wireless device.

14. The apparatus of claim 13, further comprising:
said processor configured to:
measure channel conditions of the wireless device during said actively sensing.

15. The apparatus of claim 13, further comprising:
said processor configured to:
exchange data with the wireless device after the actively sensing step.

16. The apparatus of claim 13, further comprising:
said actively sensing postponing data transfer until it is possible to use a predefined usable rate.

17. The apparatus of claim 13, further comprising:
said actively sensing postponing data transfer until an expected number of retransmissions is below a threshold.

18. The apparatus of claim 13, further comprising:
said actively sensing postponing data exchange to wait for better conditions when channel quality improves.

19. The apparatus of claim 13, further comprising:
said actively sensing giving higher priority to data exchange when channel quality decreases, before conditions become too bad for communication.

20. The apparatus of claim 11, further comprising:
said processor configured to:
request the wireless device to reduce its own beacon group size before allowing the wireless device to join the first named beacon group.

21. A computer readable medium, comprising:
a computer readable medium having computer program code therein;
program code in said computer readable medium, for participating in a beacon group;
program code in said computer readable medium, for receiving a beacon message from a wireless device;
program code in said computer readable medium, for determining whether the received beacon message is received from a wireless device synchronized to the beacon group; and
program code in said computer readable medium, for ignoring the received beacon message when the received beacon message is received from a wireless device not synchronized to the beacon group;
wherein participating in the beacon group comprises transmitting beacons across a wireless transmission medium, including information for maintaining synchronization between wireless devices in the group, the beacon transmissions being sent in respective beacon slots reserved for respective ones of the wireless devices in the group.

22. The computer readable medium of claim 21, further comprising:
program code in said computer readable medium, for allowing the wireless device to join the beacon group when the received beacon message from the wireless device is synchronized to the beacon group.

23. The computer readable medium of claim 22, further comprising:
program code in said computer readable medium, for actively sensing by exchanging a sequence of test frames with the wireless device using a plurality of modes supported by the wireless device.

24. The computer readable medium of claim 23, further comprising:
program code in said computer readable medium, for measuring channel conditions of the wireless device during said actively sensing.

25. The computer readable medium of claim 23, further comprising:
program code in said computer readable medium, for exchanging data with the wireless device after the actively sensing step.

26. The computer readable medium of claim 23, further comprising:
said actively sensing postponing data transfer until it is possible to use a predefined usable rate.

27. The computer readable medium of claim 23, further comprising:
said actively sensing postponing data transfer until an expected number of retransmissions is below a threshold.

28. The computer readable medium of claim 23, further comprising:
said actively sensing postponing data exchange to wait for better conditions when channel quality improves.

29. The computer readable medium of claim 23, further comprising:
said actively sensing giving higher priority to data exchange when channel quality decreases, before conditions become too bad for communication.

30. The computer readable medium of claim 21, further comprising:
program code in said computer readable medium, for requesting the wireless device to reduce its own beacon group size before allowing the wireless device to join the first named beacon group.

31. An apparatus, comprising:
means for participating in a beacon group;
means for receiving a beacon message from a wireless device;
means for determining whether the received beacon message is received from a wireless device synchronized to the beacon group; and
means for ignoring the received beacon message when the received beacon message is received from a wireless device not synchronized to the beacon group;
wherein participating in the beacon group comprises transmitting beacon transmissions across a wireless transmission medium, including information for maintaining synchronization between wireless devices in the group, the beacon transmissions being sent in respective beacon slots reserved for respective ones of the wireless devices in the group.

32. The method of claim 3, further comprising:
before allowing the wireless device to join the first named beacon group, the wireless device has autonomously reduced its own beacon group size.

33. The apparatus of claim 13, further comprising:
before allowing the wireless device to join the first named beacon group, the wireless device has autonomously reduced its own beacon group size.

34. The computer readable medium of claim 23, further comprising:
before allowing the wireless device to join the first named beacon group, the wireless device has autonomously reduced its own beacon group size.
